(19) United States
(12) Patent Application Publication
(10) Pub. No.: US 2008/0011497 A1
(43) Pub. Date: Jan. 17, 2008

(54) Power drill cultivator attachment

(76) Inventor: Bruce Leon Catlin, West Valley City, UT (US)

Correspondence Address: MARCUS G THEODORE, PC, 466 SOUTH 500 EAST, SALT LAKE CITY, UT, 84102, US

(21) Appl. No.: 11/485,056

(22) Filed: Jul. 12, 2006

(51) Int. Cl. A01B 13/08

(52) U.S. Cl. 172/699

(57) ABSTRACT

An improved power drill cultivator blade attachment for use with smaller plots and provides the advantages of an improved tiller blade design, which can be used laterally as well as horizontally to minimize migration.

### BACKGROUND OF THE INVENTION

1. Field

This invention pertains to cultivators. More particularly, it relates to cultivator attachment for a conventional power drill.

2. State of the Art

A number of cultivators are known. Hound Dog Products, Inc. of Eden Prairie, Minn. produces a number of hand powered hand tool cultivators, such as its three pronged Mini-Tiller, and its six pronged Garden Hound Tiller. These manual tools require a user to rotate the tool prongs to till the soil and are of limited use for smaller plots. Faultless Starch/Bon Ami Company of Kansas City, Mo. also produces a similar line of hand cultivators, such as its Garden Claw™.

Other powered cultivators such as Howard, U.S. Pat. No. 5,810,093 issued Sep. 22, 1998 disclose a multipurpose landscaping device for use as a hand-held rotary power tool. It has a shaft with one end adapted for attachment to a power drill, and the other end adapted for use with a greenery cutter, a blower, a pruner, a U-shaped soil auger and a weed extractor. Jerez, U.S. Pat. No. 5,491,963 issued Feb. 20, 1996 discloses a garden cleaning implement with rotating rectangular blade cutting members for cutting/macerating weeds above and below ground. Jerez, U.S. Pat. No. 6,247,539 issued Jun. 19, 2001 discloses a cultivator implement with castellated cultivating protrusions and multi-implement powered cultivation system using spool filament and bumper feed for cutting. Marshall et al, U.S. Pat. No. 6,189,627 issued Feb. 20, 2001 discloses a lawn and garden tool arranged to provide low speed and high torque to power various implements such as tillers and drills. Marshall's tiller blade arrangement has a tendency to wander when in use and consequently requires directional control assistance from a handle.

Other farm tiller implements employing riding vehicles are known, but are not suitable for use with smaller plots or gardens.

Cited for general interest is Spence, U.S. Pat. No. 4,289,214 issued Sep. 15, 1981 disclosing a multi-purpose vehicle, which can be used with tillers and other farm implements.

The invention described below provides an improved power drill cultivator blade attachment for use with smaller plots and provides the advantages of an improved tiller blade design, which can be used laterally as well as horizontally to minimize migration.

### SUMMARY OF THE INVENTION

The invention comprises a cultivating blade attachment comprising a shaft with an attachment end adapted to attach to a low speed high torque rotary power source such as a variable speed drill. At the other end it has a cultivator end with at least three spaced apart blades attached to the cultivator end. Each blade is bent away from the shaft such that its tips are separated and adapted to drill into the soil as the cultivating blade attachment is rotated such that the soil is tilled without blade migration.

In the simplest embodiment, three blades are attached to the cultivator end of the shaft, and the attachment end is adapted to fit within a drill chuck. To prevent the cultivating blade attachment from migrating during use, a vertical drill stabilizer is positioned in the center of the spaced apart blade extending there beyond to drill into the soil and hold the position of the cultivating blade attachment as the rotating blades cultivate and till the soil. This particular embodiment is used to “drill” a series of cultivating holes to churn and till the soil. A user can then remove the loosened weeds or till them into the soil for mulch.

A second pair of horizontal stabilizer blades may be interposed between the four equally spaced apart stabilizer blades with their tips spread apart wider than the blades such that they are not in planer alignment to act as additional horizontal stabilizers to minimize blade migration when in use.

In one preferred embodiment, the length of the shaft is adjustable to minimize user stooping. Although this adjustable shaft reduces stooping when extended, it does not enable the user to remove weeds without first laying down the cultivating tool. It does, however, eliminate the need to have different tool length shafts, if one wants to operate close to the ground, or hold the blades father away in an upright position.

When using the cultivating blade attachment in harder soils, preferably a handle is attached to the variable speed drill to assist in aligning the cultivating blade attachment. In addition, with longer shafts, a tubular hand guide may be included surrounding the shaft to enable the center shaft to spin freely within the tubular hand guide. This tubular hand guide serves as a handle or grip to assist in controlling the alignment when the user is using a longer shaft tool in a standing position.

The preferred embodiment of the cultivating blade attachment has an attachment end adapted to attach to the chuck of a low speed high torque rotary drill with a handle to assist in aligning the blade attachment. The cultivator end has at least four spaced apart blades (preferably equally spaced apart to prevent wobble during use). A central drill stabilizer is attached to the cultivator end in the center of the blades to prevent migration. Each blade extends and is bent away from alignment with the center shaft to slightly drag its tips into the soil as it rotates. This embodiment may also include a horizontal stabilizer, which allows the cultivating blade attachment to be used at an inclined angle without causing migration.

The span of the spaced apart blade tips varies as to the compactness of the soil. Smaller diameter spaced apart blade tips are used in tighter more compact soils and it areas where it is desired to work closer to the base of plants without damage to them. Wider more spaced apart blade tips with additional blades are used in larger areas or in areas where the soil is less compact requiring less torque. Thus a variety of cultivating attachments may be included in a kit and employed to meet the cultivating needs of a user under various soil conditions and types.

These cultivating blade attachments are preferably made of cast or welded metals resistant to corrosion, and of a thickness to withstand the cultivating forces incurred when in use. Steels or other metals are therefore preferred, and provide a washable tool after use.

The above cultivating blade attachment thus provides the combined advantages of a power cultivator, as well as the efficiencies of an interchangeable attachment readily adaptable for various soil conditions.

### DESCRIPTION OF THE DRAWINGS

FIG. 1 is a perspective view of a three blade cultivating blade attachment.

FIG. 2 is a perspective view of the embodiment shown in FIG. 1 with a vertical stabilizer.

FIG. 3 is a perspective view of a four blade cultivating blade attachment with a vertical stabilizer.

FIG. 4 is a perspective view of a three blade cultivating blade attachment with a horizontal stabilizer.

FIG. 5 is a perspective view of a three blade cultivating blade attachment with both vertical and horizontal stabilizers.

FIG. 6 is a perspective view of a four blade cultivating blade attachment with both vertical and horizontal stabilizers.

FIG. 7 is a perspective view of a four blade cultivating blade attachment with bent blades and a vertical stabilizer.

FIG. 8 is a perspective view of the embodiment of claim 7 with a telescoping shaft attached to a power drill.

### DESCRIPTION OF THE ILLUSTRATED EMBODIMENTS

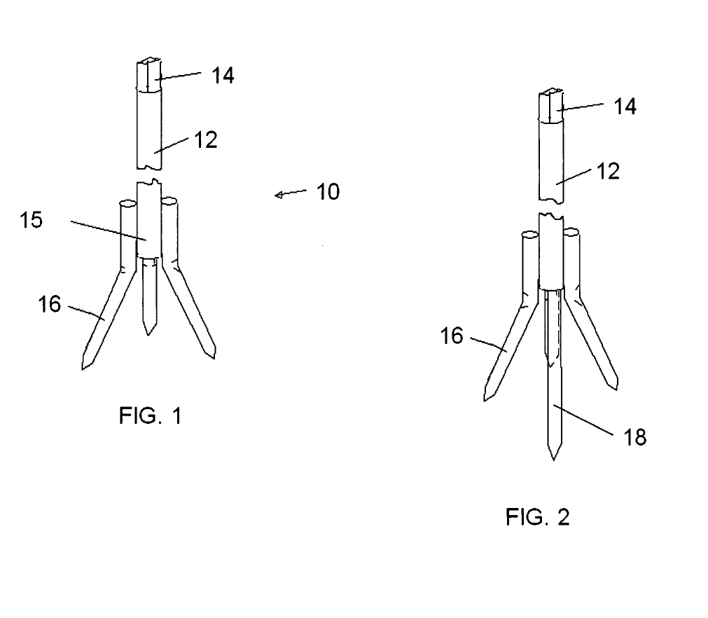

FIG. 1 is a perspective view of the simplest embodiment of the invention 10. It has a cylindrical shaft 12 with a square attachment end 14 adapted to fit within the chuck of a conventional power drill. The shaft 12 cultivating end 15 has three blades 16 attached and equally spread apart. The invention 10 is made of steel with the blades made of bent 60 penny gauge nails welded to the cultivating end 15 of the shaft 12 such that the blades 16 can be bent inwardly or outwardly, if desired to till different soils.

FIG. 2 is a perspective view of the embodiment shown in FIG. 1 with a vertical stabilizer 18, which acts as a center drill to prevent the attachment from drifting while in use.

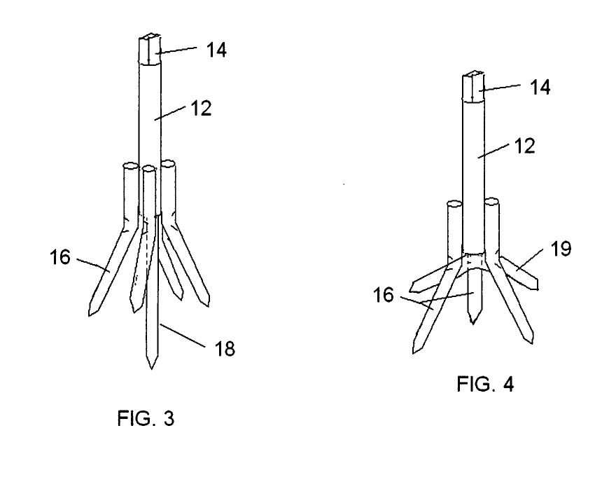

FIG. 3 is a perspective view of a four blade 16 cultivating blade attachment 10 with a vertical stabilizer 18. This embodiment provides superior cultivation when used in a vertical direction.

FIG. 4 is a perspective view of a three blade 16 cultivating blade attachment 10 with a horizontal stabilizer 19. The horizontal stabilizer 19 allows the attachment 10 to be used on an angle and prevents drifting.

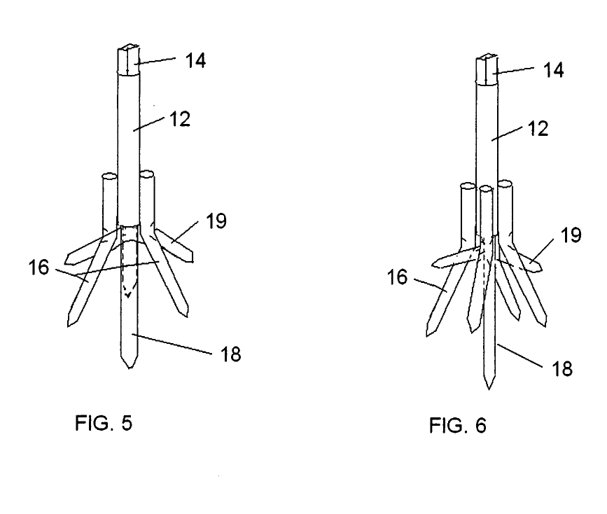

FIG. 5 is a perspective view of a three blade 16 cultivating blade attachment 10 with both vertical 18 and horizontal 19 stabilizers.

FIG. 6 is a four blade 16 cultivating blade attachment 10 with both vertical 18 and horizontal 19 stabilizers.

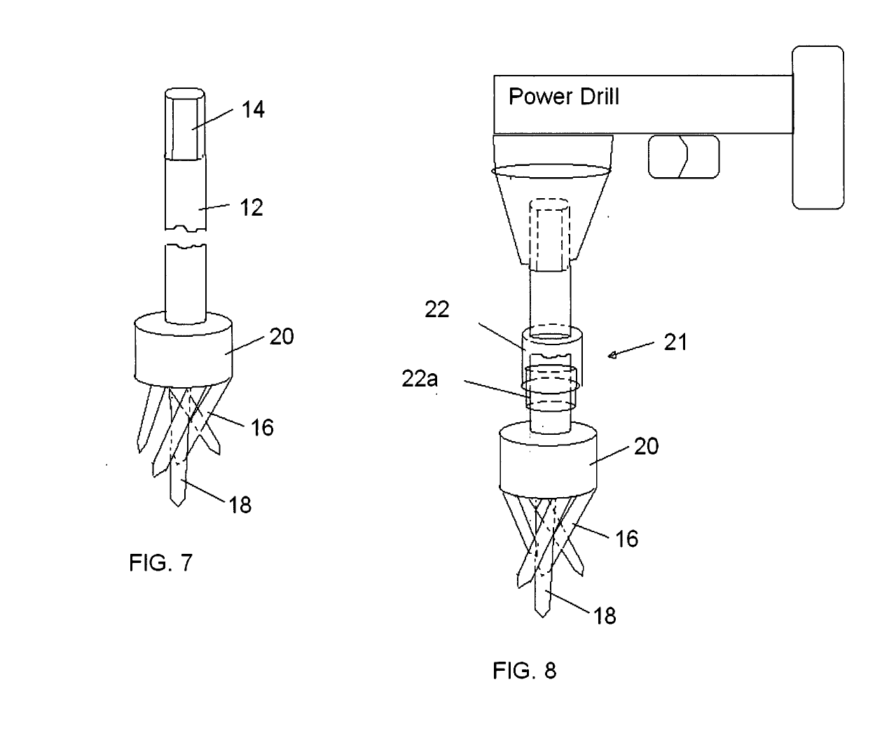

FIG. 7 is a perspective view of a four blade 16 cultivating blade attachment 10 with bent blades 16 and a vertical stabilizer 18. This embodiment has a base 20 to which the bent blades 16 are attached around the vertical stabilizer.

FIG. 8 is a perspective view of the embodiment of claim 7 with a telescoping shaft assembly 21 comprising telescoping sections 22, 22a. This telescoping shaft assembly 21 is removably attached to a power drill via a chuck as shown.

The above cultivating blade attachment thus provides the combined advantages of a powered hand cultivator, as well as the efficiencies of an interchangeable attachment blades readily adaptable for various soil conditions. It generally is made of hard metal for efficient use in all types of soils. It is ideal for soil mixing, aerating, weed destruction, with the capability to cultivate in and around plants, rocks, planting borders, side walks, under fences, decorations, and many remote places conventional tillers cannot reach. The cultivator blade attachment can be removably attached to any power drill, and may be modified to apply to other power equipment at higher levels of torque, particularly when adapted with the vertical stabilizer, which allows its usage at medium to high speed settings. If operated at higher speeds, soil is thrown and dispersed. At lower speeds the cultivator blade attachment disturbs soil very little and allows uprooting of weeds without tearing, making complete removal possible, or burying them for composting.

Although this specification has referred to the illustrated embodiments, it is not intended to restrict the scope of the appended claims. The claims themselves recite those features deemed essential to the invention.

1. A cultivating blade attachment comprising:
a. a shaft with
i. an attachment end adapted to attach to a rotary power source, and
ii. a cultivator end
b. at least three spaced apart blades attached to the cultivator end with tips adapted to drill into the soil as the cultivating blade attachment is rotated by the power source such that the soil is tilled.

2. A cultivating blade attachment according to claim 1, with stabilizer means attached to the cultivator end and structured to prevent blade migration, during rotational usage.

3. A cultivating blade attachment according to claim 1, wherein the rotary power source is a variable speed drill and the attachment end is adapted to fit within a drill chuck.

4. A cultivating blade attachment according to claim 2, wherein the stabilizer means comprises a central drill point attached to the center of the cultivator end to extend beyond the tips of the blades and drill into soil.

5. A cultivating blade attachment according to claim 2, wherein the stabilizer means comprises a horizontal pair of blades interposed between the spaced apart blades with the horizontal blade tips spread apart wider and not in planer alignment with the spaced apart blade tips to act as a horizontal stabilizer to minimize blade migration when in use.

6. A cultivating blade attachment according to claim 1, wherein the length of the shaft is adjustable.

7. A cultivating blade attachment according to claim 4, wherein the shaft is of a length to allow use of the cultivating blade without a user having to stoop.

8. A cultivating blade attachment according to claim 2, including a handle attached to the variable speed drill to assist in aligning the cultivating blade attachment.

9. A cultivating blade attachment comprising:
i. a shaft with an attachment end adapted to attach to a chuck of a variable speed low to high torque rotary drill having a handle to assist in aligning the cultivating blade attachment, and a cultivator end,
ii. at least four equally spaced apart blades attached to the cultivator end with each blade bent such that their tips are spaced apart and planarly aligned, and
iii. a vertical central drill point attached to the center of the cultivator end to extend beyond the tips of the blades and adapted to drill into the soil such that the soil is tilled without blade migration.

10. A cultivating blade attachment according to claim 9, including a second horizontal blade interposed between the four equally spaced apart blades with the tips of the horizontal blade spread apart wider and not in planer alignment with the tips of the four equally spaced apart blades, which act as horizontal stabilizers to minimize blade migration when in use on an incline.
